(19) United States
(12) Patent Application Publication
(10) Pub. No.: US 2023/0071589 A1
(43) Pub. Date: Mar. 9, 2023

(54) AN ABRASION RESISTANT MULTI-LAYERED COMPOSITE

(71) Applicant: ELKEM SILICONES SHANGHAI CO., LTD., Shanghai (CN)

(72) Inventors: Wenjuan ZHOU, Shanghai (CN); Yongji ZHU, Shanghai (CN); Zhiguang SUN, Shanghai (CN)

(21) Appl. No.: 17/790,377

(22) PCT Filed: Dec. 30, 2019
(86) PCT No.: PCT/CN2019/129879

§ 371 Date: Jun. 30, 2022

(51) Int. Cl. C08G 77/20; C09D 183/04; C09J 183/04; C08K 7/16; C08G 77/00

(52) U.S. Cl. CPC C08G 77/20; C09D 183/04; C09J 183/04; C08K 7/16; C08G 77/70; C08K 2201/005

(57) ABSTRACT

Described herein is a multi-layered composite including a substrate, an adhesive layer and a top coat layer, the top coat layer being formed by a silicone coating composition including: (A) at least one organopolysiloxane polymer having at least two alkene functions; (B) at least one cross-linking organohydrogensiloxane having at least two Si—H groups; and (C) a catalyst capable of promoting the reaction between component (A) and component (B); wherein the component (B) contains at least 25%, preferably at least 30%, more preferably at least 45% by weight of component (B) of a three-dimensional net-like organohydrogensiloxane resin (B′) containing at least two different units selected from a group including: units M of formula R′₃SiO_{1/2}; units D of formula R′₂SiO_{2/2}; units T of formula R′SiO_{3/2}; and units Q of formula SiO_{4/2}, wherein R′ represents hydrogen atom or a monovalent hydrocarbonyl group having from 1 to 20 carbon atoms, and with the proviso that at least one of these units is the unit T or Q, preferably Q, and at least one of the units M, D and T comprises a hydrogen atom. Also described, are embodiments where the multi-layered composite has a surface with excellent abrasive resistance and good mechanical properties.

### TECHNICAL FIELD

The invention relates to a multi-layered composite with a surface having excellent abrasive resistance and good mechanical properties, a specific silicone coating used for surface modification and a product containing the multi-layered composite.

### BACKGROUND OF THE INVENTION

Currently, because of the severe health and environmental issues occurring during the production of the traditional industrial artificial leather polyurethane (PU) and polyvinylchloride (PVC), more and more companies or organizations are considering research and develop the silicone artificial leather. Coating textile fabrics with silicone-based coating compositions has been well known for recent years. These compositions may impart a variety of benefits to the coated fabric.

U.S. Pat. No. 6,037,279 describes a coated textile fabric for fabricating automobile airbags. The surface of the textile fabric is coated with first and second layers of organopolysiloxane-based elastomeric material which comprise a certain polydiorganosiloxane having alkenyl groups, an inorganic filler, a certain organopolyhydrosiloxane and a platinum group metal catalyst. The organopolysiloxane-based material of the first layer exhibits an elongation-at-break of at least 400%. The organopolysiloxane-based material of the second layer exhibits a tear-strength of at least 30 kN/m. In this invention a layer of low frictional performance can be added over the second layer, such as an elastoplastic organopolysiloxane resin, to provide a smooth dry surface.

KR101381914B1 provided a synthetic leather which is used as an interior material of an aircraft or a ship having a structure in which a first coating layer having a shore hardness (shore A) of 50 or more and an elongation at break of less than 300% is laminated on a textile by a second coating layer having a shore hardness (shore A) less than 50 and an elongation at break of 300% or more. The three-layer synthetic leather provides properties such as flame retardance, heat resistance, contamination resistance, solvent resistance and hydrolysis resistance.

CN107000394A provides a method for producing a fabric substrate molded product coated with silicone rubber. The adherence of dust, flashes during molding, and foreign matter is prevented because the cured coating film has surface lubricity, and breaking and cracking do not occur when the fabric substrate is defoamed. The product has a slip surface by improving the material hardness.

US20060058436 relates to an aqueous abrasion resistant coating composition used in the seals surface, comprising at least one crosslinkable resin and optionally at least one crosslinking agent, and spherical particles of at least one polyalkylsiloxane comprising R¹—SiO_{3/2} groups, whereby R¹ is C1-C18 alkyl, and/or spherical particles of at least one polysiloxane which are coated with at least one polyalkylsiloxane comprising R₁—SiO_{3/2} groups, whereby R¹ is C1-C18 alkyl.

CN103821008A discloses a silicone textile leather comprising silicone resin, silicone rubber and silica which has a three-layered structure. The third layer contains a base rubber, block-type silicone resin and Si—H group containing crosslinking agent. However, the patent does not mention the contribution of the Si—H group-containing crosslinking agent and the special structure in the wear resistance and smooth sense of respect.

WO2019095605 teaches a silicone synthetic leather comprising a surface adhesive layer, a bottom adhesive layer and a base layer that are overlaid in sequence. The preparation materials of the surface adhesive layer mainly comprise organic polysiloxane, organic hydrogenated polysiloxane, a vinyl MTQ silicone resin and a spherical vinyl MQ silicone resin, which are mixed at an appropriate ratio to obtain a surface adhesive. The surface layer has excellent abrasive resistance by using spherical vinyl MQ silicon resin to participate in hydrosilyzation reaction.

There continues to be a need to overcome the disadvantages of the traditional PU/PVC synthetic leather or genuine leather and improve the hand feeling and abrasion resistance of the silicone leather while still keeping good mechanical properties. Furthermore, it is also desired to develop a silicone coating composition which can be used for surface modification of not only synthetic leather but also extensive industrial articles.

### SUMMARY OF INVENTION

The inventors of the instant application have surprisingly found that the above-mentioned task can be solved by using a multi-layered composite and a specific silicone coating composition as defined below. With the inventive multi-layered composite, a good hand feeling and excellent mechanical properties can be achieved and the product containing it are completely environmental friendly and has less odor.

In a first aspect, the invention relates to a multi-layered composite comprising a substrate, an adhesive layer and a top coat layer, said top coat layer being formed by a silicone coating composition comprising following components:
(A) at least one organopolysiloxane polymer having at least two alkene functions containing:
   (i) at least two units of formula (I-1)

R¹ₐZ_{b}SiO_{[4-(a+b)]/2} (I-1)
in which
   R¹ represents a monovalent radical containing from 2 to 12 carbon atoms, having at least one alkenyl group,
   Z may be the same or different and represent a monovalent radical containing from 1 to 20 carbon atoms and does not comprise an alkenyl group,
   a is an integer of 1, 2 or 3, b is an integer of 0, 1 or 2 and the sum of a+b is 1, 2 or 3,
(ii) and optionally other units of formula (I-2):

Z_{c}SiO_{(4-c)/2} (I-2)
in which
Z has the same meaning as above, and
c is an integer of 0, 1, 2 or 3;
(B) at least one cross-linking organohydrogensiloxane having at least two Si—H groups; and
(C) a catalyst capable of promoting the reaction between component (A) and component (B);
characterized in that the component (B) contains at least 25 wt %, preferably at least 30 wt %, more preferably 45 wt % by weight of a three-dimensional net-like organohydrogensiloxane resin (B′) containing at least two different units selected from the group comprising or consisting of
units M of formula R′₃SiO_{1/2},
units D of formula R′₂SiO_{2/2},
units T of formula R′SiO_{3/2} and
units Q of formula SiO_{4/2}, wherein R′ represents hydrogen atom or a monovalent hydrocarbonyl group having from 1 to 20 carbon atoms, and
   with the proviso that at least one of these units is the unit T or Q, preferably Q, and at least one of the units M, D and T comprises a hydrogen atom.

In a second aspect, the invention relates to a product containing such a multi-layered composite, preferably an artificial leather, an airbag or an apparel.

In a third aspect, the invention relates to use of the inventive silicone coating composition as defined above for surface modification of silicone coated textiles, such as in heat shielding and DWR (Durable Water Repellent) coatings, silicone inks in textile screen printing, airbags and injection molded parts, and for applying directly to textile for apparel printing.

The other subject matters and the preferred embodiments are included in the claim set of the instant application.

### Embodiments of Invention

Multi-Layered Composite

In a first aspect, the invention relates to a multi-layered composite comprising a substrate, an adhesive layer and a top coat layer, said top coat layer being formed by an inventive silicone coating composition which is described hereafter in more detail.

The substrate is the first layer. It may be a fabric, film, membrane, cloth or sheet based on the polymers selected from polypropylene, polyethylene, fiberglass, polyamides, polyurethane and polyvinyl chloride, poly(ethylene) terephthalate and other polymers or mixtures thereof. The fabric may be woven fabric or a nonwoven fabric. The woven fabric may have threads with a thickness that is equal to or greater than 20 dtex. When the substrate is a nonwoven fabric or a polymeric film, it may have a basis weight between about 40 g/m² and about 400 g/m².

In particular, the substrate is a flexible fabric, membrane, cloth or sheet, or a supporting material used in the clothing, apparel or leather industries. Preferably, the substrate is not an optical or electronic or conductive substrate or part of the device or appliance.

An adhesive layer is usually arranged between the top coat and the substrate and it may be a continuous or discontinuous layer. In a simplest embodiment, the inventive multi-layered composite may be consisting of these three layers. However, in order to improve the bonding force or equip the composite with other functions, other intermediate layers such as primer layer may be included in the inventive multi-layered composite and/or a decorative layer may be applied on the top coat.

Silicone Coating Composition

In the context of the instant description, the terms “silicone coating composition”, “silicone coating” and “top coat” are synonymous and may be used interchangeably, unless otherwise indicated. The inventive silicone coating composition is applied as a top coat and it forms an elastomeric silicone resin top coat upon curing.

The skilled person is aware that the so-called silicone coating composition is usually applied in form of liquid and should comprise or substantially consists of the organosilicon compounds, polymer or resin as the main constituent of the polymer matrix. In one advantageous embodiment, the polymer matrix of the silicone coating composition makes up at least 50 wt %, preferably at least 65 wt %, more preferably at least 80 wt %, most preferably 90 wt % or 95 wt % or even 100 wt % of the total amount of components (A) and (B).

With the inventive silicone coating composition, the performance of the silicone original property like environment friendly can be imparted to the final products. It can also improve the product hardness and make less smell. Furthermore, it can also provide high abrasion resistance and also good hand feeling at the same time, especially in combination with appropriate microsphere or microsphere like fillers. For example, the abrasion resistance of the top coat layer may be ranked according to ASTM D4157 at Ranking 5 after at least 100,000 scrubbing.

Moreover, in one preferable embodiment of the invention, the inventors have found that the hand feeling and abrasion resistance, in particular measured according to ASTM D4157 by Wyzenbeek, can be greatly improved if the inventive silicone coating composition contains further component (D) which are spherical particles with a particle size D50 from 0.2 to 60 μm, preferably from 0.5 to 40 μm.

Component (A)

Component (A) in the silicone coating composition is at least one organopolysiloxane polymer having at least two alkene functions, or mixture thereof. The alkene functions may be at any position on the main chain of the organopolysiloxane, for example at the end or in the middle or at both ends and in the middle of the molecular chain. In the context of the present disclosure, the term “alkene function” refers to the function of a C═C double bond (i.e. —C═C—) and thus the radical having an alkene function usually includes any hydrocarbon radical such as aliphatic, cycloaliphatic, aromatic, arylaliphatic radical that has at least one C═C double bond. For example, the aliphatic alkenyl groups like vinyl or allyl, or the arylalkenyl groups such as styryl can be regarded as a radical having an alkene function. In the instant invention, the radical having at least one alkene function is able to react with the hydrogen bonded to Si-atom under an addition reaction like hydrosilylation.

In one embodiment, said organopolysiloxane polymer contains:

(i) at least two units of formula (I-1)

R¹ₐZ_{b}SiO_{[4-(a+b)]/2} (I-1)
in which
   R¹ represents a monovalent radical containing from 2 to 12 carbon atoms, having at least one alkene function,
   Z may be the same or different and represent a monovalent radical containing from 1 to 20 carbon atoms and does not comprise an alkene function,
   a is an integer of 1, 2 or 3, b is an integer of 0, 1 or 2 and the sum of a+b is 1, 2 or 3,

(ii) and optionally other units of formula (I-2):

Z_{c}SiO_{(4-c)/2} (I-2)
in which
   Z has the same meaning as above, and
   c is an integer of 0, 1, 2 or 3.

Advantageously, the organopolysiloxane polymer of component (A) may substantially or entirely consist of the siloxane units of formulae (I-1) and (I-2).

The organopolysiloxane polymer may be of a linear, branched or cyclic structure. The skilled persons understand that in case of linear or branched structure the organopolysiloxane polymer may be terminated by group —R^{T} or —SiR^{T}₃ wherein R^{T}, independently from each other, denotes a hydrocarbonyl group such as alkyl, alkoxy, alkenyl or aryl.

In context of the present disclosure, the monovalent radical includes preferably hydrocarbonyl group or radical consisting of C, H and O atoms, such as alkyl, alkoxy, (meth)acrylic, alkenyl or aryl groups, that may be linear, branched or cyclic and may be substituted by one or more substituents like halogen atoms. In case of a radical or hydrocarbonyl radical having at least one alkene function, at least one C—C bond in the radical may be replaced by C═C double bond.

In the context of the present disclosure, alkyl and alkoxy groups may advantageously have 1 to 18, more preferably 1 to 12, most preferably 1 to 8 carbon atoms and may be substituted or unsubstituted by halogens like fluorine. Examples of alkyl and alkoxy groups include methyl, ethyl, propyl, 3,3,3-trifluoropropyl, methoxy and ethoxy groups. Alkenyl groups may preferably have 2 to 12, more preferably 2 to 8 carbon atoms and thus include for example vinyl, propenyl and allyl groups. Aryl groups may have preferably 6 to 20, more preferably 6 to 12 carbon atoms and may be substituted or unsubstituted by halogens like fluorine. Thus, examples of aryl group include phenyl, tolyl, xylyl or naphthyl group.

Group R¹ is a reactive radical in the present invention and may be preferably selected from alkenyl groups, such as vinyl or allyl.

Group Z is a non-reactive radical in the present invention and may be selected from alkyl, alkoxy and aryl groups. In one exemplary embodiment, Z is selected from C₁-C₈ alkyl group, and/or C₆-C₂₀ aryl groups.

Examples of the units of formula (I-1) may include vinyl dimethylsiloxy, vinylphenylmethylsiloxy, vinyl methylsiloxy and vinyl siloxane units.

The examples of the unit of formula (I-2) are SiO_{4/2} unit, dimethyl siloxy, methyl phenyl siloxy, diphenyl siloxy, methyl siloxy and phenyl siloxy group.

Examples of the organopolysiloxane polymer may include linear or cyclic compounds such as dimethylpolysiloxane (including dimethylvinylsilyl end group), (methylvinyl) (dimethyl) polysiloxane copolymers (including trimethylsilyl end group), (methylvinyl) (dimethyl) polysiloxane copolymers (including dimethylvinylsilyl end group) and cyclic methyl vinyl polysiloxane.

In one preferable embodiment of component (A), the organopolysiloxane polymer may include alkenyl organopolysiloxane resin (A′) comprising or consisting of:
at least two different units selected from the group consisting of units M of formula R₃SiO_{1/2}, units D of formula R₂SiO_{2/2}, units T of formula RSiO_{3/2} and units Q of formula SiO_{4/2}, wherein R have the meanings given for groups R¹ or Z in claim 1,

with the proviso that at least one of these units is the siloxane unit T or Q and at least two of the units M, D and T comprises an alkene function, preferably alkenyl group.

For example, the preferred exemplary organopolysiloxane resin (A′) may include:
an organopolysiloxane resin of formula M^{VI}Q
an organopolysiloxane resin of formula MM^{VI}Q
an organopolysiloxane resin of formula M^{VI}T^{VI}Q
an organopolysiloxane resin of formula M^{VI}TQ, and
an organopolysiloxane resin of formula M^{VI}DQ,

wherein “M^{VI}”, “T^{VI}” or “D^{VI}” refers to the unit “M”, “T” and “D” which contains one alkenyl or preferably vinyl group, respectively.

Advantageously, the alkenyl organopolysiloxane resin (A′) has a weight average molecular weight in the range of from 200 to 100,000, preferably from 200 to 50,000, more preferably from 500 to 30,000. Here, the weight average molecular weight can be obtained by gel permeation chromatography and using polystyrene as a standard.

Advantageously, if all or substantially all of the alkenyl groups in the organopolysiloxane polymer or preferably alkenyl organopolysiloxane resin (A′) are bonded to the siloxane unit M (M^{VI} unit) or siloxane unit D (D^{VI} unit), the silicone compositions of the present disclosure are able to cure at room temperature or higher temperatures more rapidly than those having the alkenyl groups to be bonded in other manners.

Above mentioned are merely some examples of the alkenyl organopolysiloxane resin (A′). It will be apparent to those skilled in the art that resins constituted by the units M, T, D and Q in other possible manners are also suitable for use as the polysiloxane resin.

In one preferred embodiment, the component (A) contains 8 wt % to 80 wt %, preferably 10 wt % to 60 wt %, more preferably 15 wt % to 50 wt % by total weight of the component (A) of alkenyl organopolysiloxane resin (A′).

In addition to the organopolysiloxane resin, the organopolysiloxane may be used which may have a viscosity of at least 50 mPa·s and preferably less than 200,000 mPa·s. In the present disclosure, all viscosity data are concerned with dynamic viscosity values and can be measured, for example, in a known manner at 25° C. using a Brookfield instrument, unless otherwise specified.

In the context of the present disclosure, when referring to a composition or component, in particular a organopolysiloxane resin or component (A) and (B), the term “(substantially) . . . consisting of/comprising” means that the related composition or component comprises more than 50% by weight, for example, at least 60% by weight, at least 70% by weight, or at least 80% by weight, or even 100% by weight of the listed substances, based on the total weight of the related composition or component.

Component (B)

Component (B) is at least one cross-linking organohydrogensiloxane having at least two Si—H groups (i.e. silicon-bonded hydrogen), or a mixture thereof, which is capable of reacting with the alkene function of Component (A) described above. The organohydrogenpolysiloxane compound may be monomer, oligomer or polymer.

In one embodiment, the cross-linking organohydrogenpolysiloxane having at least two Si—H groups, preferably three Si—H groups, may comprise:

(i) at least one units and preferably at least two or three units having the following formula:

$${H}_{d} {Z}_{e}^{3} {SiO}_{\frac{4 - ( d + e )}{2}} \qquad ( II - 1 )$$

in which:
d=1 or 2 or 3, e=0, 1 or 2 and d+e=1, 2 or 3,
Z³ have the same meaning as given to group Z and is preferably selected from C₁-C₈ alkyl and C₆-C₂₀ aryl groups, and

(ii) optionally at least one unit having the following formula:

$${Z}_{f}^{3} {SiO}_{\frac{4 - f}{2}} \qquad ( II - 2 )$$

in which:
f=0, 1, 2 or 3,
Z³ may be identical or different and have the same meanings as given above.

In a preferred embodiment, Z³ may be selected from the group consisting of methyl, ethyl, propyl, 3,3,3-trifluoropropyl, phenyl, xylyl and tolyl and so on.

Likewise, the skilled person also understands that in case of linear or branched structure of organohydrogenpolysiloxane, it may be terminated by group —R″ or —SiR“₃ wherein R”, independently from each other, has the meaning given for groups Z³ or represents H.

Examples of the units of formula (II-1) include H(CH)₂SiO_{1/2}, HCH₃SiO_{2/2} and H(C₆H₅)SiO_{2/2}.

Examples of the units of formula (II-2) may be the same as those given above for the units of formula (I-2).

Examples of the hydrogen-containing polysiloxane include linear, branched or cyclic compounds such as dimethylpolysiloxane (including hydrogenated dimethylsilyl end group), copolymers having (dimethyl) (hydromethyl) polysiloxane units (including trimethylsilyl end group), copolymers having (dimethyl) (hydromethyl) polysiloxane units (including hydrogenated dimethylsilyl end group), hydrogenated methyl polysiloxane having trimethylsilyl end group and cyclic hydrogenated methyl polysiloxane.

In some cases, the hydrogen-containing polysiloxane may be a mixture of a diorganopolysiloxane containing hydrogenated dimethylsilyl end group and an organopolysiloxane containing at least three hydrosilyl groups.

However, in order to achieve the inventive effects as set forth above, the inventors have found that the component (B) must contain at least 25 wt %, preferably at least 30 wt %, more preferably at least 45 wt % by weight of component (B) of a three-dimensional net-like organohydrogensiloxane resin (B′) containing at least two different units selected from the group comprising or consisting of
units M of formula R′₃SiO_{1/2},
units D of formula R′₂SiO_{2/2},
units T of formula R′SiO_{3/2} and
units Q of formula SiO_{4/2}, wherein R′ represents hydrogen atom or a monovalent hydrocarbonyl group having from 1 to 20 carbon atoms, and

with the proviso that at least one of these siloxane units is the siloxane unit T or Q, preferably Q, and at least one, preferably two, of the siloxane units M, D and T comprises a hydrogen atom.

In one preferable embodiment, the component (B) may consist of or comprise 100 wt % of said three-dimensional net-like organohydrogensiloxane resin (B′). As shown in the examples, with component (B) entirely consisting of the organohydrogensiloxane resin (B′), both hand feeling and abrasion resistance may be more improved than using the mixture of organohydrogensiloxane oil and resin as component (B).

In a further preferred embodiment, the mole ratio of M unit to Q unit in said organohydrogensiloxane resin (B′) is from 0.5 to 8 mol/mol, preferably from 0.5 to 6 mol/mol, more preferably from 0.8 to 5 mol/mol.

In addition to the organohydrogensiloxane resin, the organohydrogensiloxane may be used which may preferably have a viscosity of not greater than 1000 mPa·s at 25° C. and more preferably 2 to 500 mPa·s at 25° C.

It is desirable in the silicone coating composition that the molar ratio of silicon-bonded hydrogen atoms (Si—H groups) to the sum of the silicon-bonded vinyl groups (Si-Vinyl groups) in whole composition is from 0.8 to 10 mol/mol, preferably from 1.1 to 6 mol/mol, and more preferably from 1.2 to 5 mol/mol. If less than 0.8 mol/mol, crosslinking is in adequate and mechanical strength may be impaired or the suppression of surface tack may be inadequate. On the other hand, if more than 10 mol/mol, the mechanical characteristics after curing may decline, with the heat resistance, abrasion resistance and compression set in particular worsening dramatically.

Component (C)

Component (C) is a catalyst capable of catalyzing or promoting the hydrosilylation reaction between component (A) and component (B). Such a catalyst and the preparation thereof are well known to the skilled person.

The catalyst may comprise platinum group metal-based catalyst such as rhodium, ruthenium, palladium, osmium, irridium or platinum containing catalysts. Platinum-based catalysts are particularly preferred and may take any of the known forms, ranging from platinum deposited onto carriers, for example powdered charcoal, to platinic chloride, salts of platinum, chloroplatinic acids, and encapsulated forms thereof. A preferred form of platinum catalyst is chloroplatinic acid, platinum acetylacetonate, complexes of platinous halides with unsaturated compounds such as ethylene, propylene, organovinylsiloxanes, and styrene; hexamethyldiplatinum, PtCl₂, PtCl₃, PtCl₄, and Pt(CN)₃. Alternatively, the platinum group catalyst is a platinum catalyst. Suitable forms of platinum catalysts include but are not limited to chloroplatinic acid, 1,3-diethenyl-1,1,2,2-tetramethyldisiloxane platinum complex, complexes of platinous halides or chloroplatinic acid with divinyldisiloxane and complexes formed by the reaction of chloroplatinic acid, divinyltetrahmethyldisiloxane and tetramethyldisiloxane.

Component (C) is used in an amount sufficient to crosslink the present silicone rubber composition within a desired time, which can be typically determined by routine experimentation. Generally, the effective amount of hydrosilylation catalysts such as platinum-based catalyst may be for example from about 0.05 to 1000 ppm, preferably from 1 to 100 ppm, more preferably 2 to 50 ppm by weight per total weight of the composition.

Component (D)

In one preferable embodiment of the invention, the silicone coating composition contains component (D) which are spherical particle fillers with a particle size D50 from 0.2 to 60 μm, preferably from 0.5 to 40 μm, more preferably from 0.8 to 30 μm. As the spherical particles used herein, it is preferred that the spherical particle fillers are selected from the precipitated silica particles, spherical silicone resin particles, polyamide particles and the mixture thereof. In addition to the common filler functions like reinforcement to the coating, these specific spherical particle fillers are found to be able to surprisingly result in the improved hand feeling, especially a slip, elastic and silk-like slide feeling, and meanwhile a high abrasion resistance.

Furthermore, the amount of component (D) is preferably from 1 wt % to 30 wt %, preferably from 1.5 wt % to 25 wt %, more preferably from 2 wt % to 20 wt %, by total weight of whole composition. The inventors have found that less than 1 wt % of the specific spherical particles may probably worsen the hand feeling and hurt both the mechanical strength and abrasion resistance of the system, while higher than 30 wt % may probably render the coating more liable to crack or embrittlement with the hand feeling deteriorated.

The morphology of the component (D), i.e. the sphere or microsphere form of specific particle size D50 as defined above, may be advantageous for the desired property improvement as shown in the examples below.

With the specific average particle size of D50 within the scope of around 0.2-60 μm, preferably 0.5-40 μm, it provides very slip touching feeling as well as high abrasion resistance, in some cases also improved thermal stability and water resistance. Particle Size Distribution D50 is also known as the median diameter or the medium value of the particle size distribution, it is the value of the particle diameter at 50% in the cumulative distribution. It is one of an important and well known parameter characterizing particle size. The size distribution and volume mean diameter for a particle size distribution may be calculated using a laser light scattering PSD system such as those commercially available from Malvern. If the particle size D50 is less than 0.2 μm, it would be very difficult to prepare such small particles while still keeping spherical form. If the particle size D50 is more than 60 μm, it would not impart the cured films with the required strength and flexibility. Furthermore, working outside the given D50 range, it may result in a bad hand feeling or a lower abrasion resistant of the cured coating composition.

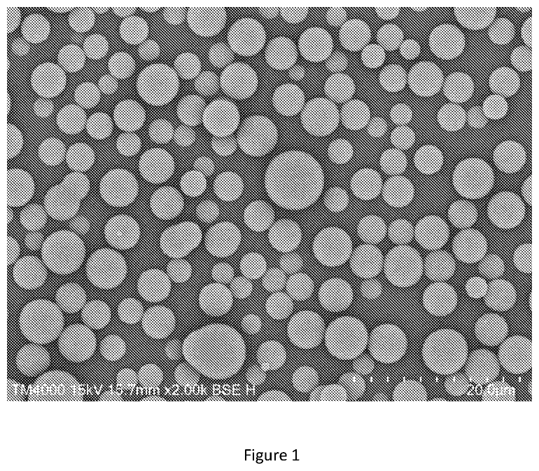

The spherical particles refer to particles of a spherical shape having one or more nearly spherical diameter across the centroid or geometric center and may be spherical particles having uneven surface. In particular, the spherical particles have a ratio of shortest diameter to longest diameter from 0.2 to 1, preferably 0.3 to 1 or such as 0.4 to 0.5 to 0.6 to 0.9 or 0.7 to 0.9. For example, FIG. 1 shows the spherical morphology of the T unit silicone resin particles which are used as Component D-2 in examples.

The precipitated silica is an amorphous form of silica which is well known in the art and it is produced by precipitation from a solution containing silicate salts. The precipitated silica is distinct from pyrogenic silica, fumed silica or silica gel and the latter three silica are not suitable for the instant invention because of their morphology and particle size. For example, the powders of fumed silica or pyrogenic silica are such unduly fine that they are usually apt to agglomerate in an irregular non-spherical shape.

In order to better compatible with the silicone component in the coating composition, the surface of the precipitated silica particles may be rendered hydrophobic. Rendering the filler particles hydrophobic may be done either prior to or after dispersing the precipitated silica particles in the polysiloxane component. This can be affected by pre-treatment of the silica particles with the hydrophobing agents like fatty acids, reactive silanes, wax or reactive siloxanes. Examples include but are not limited to stearic acid, dimethyldichloro silane, trimethylchloro silane, hexamethyldisilazane, hydroxyl endblocked or methyl end blocked polydimethylsiloxanes, siloxane resins or mixtures of two or more of these. The precipitated silica particles which have already been treated hydrophobic are commercially available in the market. Most preferred hydrophobing agent is hexamethyldisilazane or polyethene wax.

It is recommended that the specific surface area of the precipitated silica is from 50-400 m²/g. preferably from 100-300 m²/g, as determined by a BET method.

Polyamide particles which has a spherical shape and the specific particle size D50 as given above are also preferred filler used in the silicone coating composition, providing improved multiple performance aspects of the coating composition, such as abrasion resistance, chemical resistance, gloss reduction, hardness, and also texture creation.

The examples of suitable polyamide include such as, polyamide 6, polyamide 7, polyamide 9 or polyamide 10, preferably polyamide 6. These polyamide particles have low density which is for example around 1.15 g/cm³ and can be dispersed stably and homogenously in the coating composition.

The spherical silicone resin particles are especially suitable in the invention because of their easily controlled particle size, perfect sphere shape and the compatibility with the coating composition. Regarding the useful spherical silicone resin particles, they are particles of silicone resin material formed by polysiloxanes of the general formula of R⁶ₘSiXₙO_{(4-m-n)/2},

where R⁶ is an alkyl, aryl, aralkyl or alkylaryl group having two or more carbon atoms, preferably 2 to 6 carbon atoms, preferably selected from methyl, ethyl, phenyl group or phenylethyl and 3-phenylpropyl groups,

X is a functional group selected from epoxy group, alkoxyl group, vinyl group, hydrogen group, acryloxy group, and methacryloxy group, polyethylene glycol group, hydroxyl group or amino group,

m is an integer of 0 to 2,

n is an integer of 0 to 1, and

m+n is 0 to 3.

In one preferable embodiment, the polysiloxane may contain or consist of the siloxane units selected from unit M of R⁷₃SiO_{0.5}, unit D of R⁷₂SiO, unit T of R⁷SiO_{3/2} and unit Q of SiO_{4/2},

wherein R⁷ is selected from methyl, ethyl, phenyl, phenylethyl and 3-phenylpropyl groups, hydroxyl, acryloxy, and methacryloxy, hydrogen, epoxy, or amino group,

with the proviso that the amount of unit T or unit D is higher than 50 mol %, preferably higher than 70 mol %, and more preferably higher than 80 mol %.

For example, the polysiloxane may be consisting of the units selected from T, MT, DT, MDT, MTQ and MDQ. The microsphere particles may be present in the form of core-shell powder in which the core is solid and the shell is made up of the above mentioned silicone resin material.

The spherical silicone resin particles may be added as such directly into the silicone coating composition during the preparation of the mixture or added into the mixture in form of dispersion of particles in the diluent, such with a dispersion content of 10-30 wt % based on the total weight of the dispersion, preferably 10-20 wt %. The diluent suitable for dispersing these particles are known to the skilled person and examples thereof include D4 (Octamethylcyclotetrasiloxane) or D5 (Decamethylcyclopentasiloxane).

Other Optional Components

In addition to the above-discussed components (A) to (D), the silicone coating composition according to the invention can optionally comprise further components so as to adjust the overall properties of the composition as desired.

One example of such additional components is an adhesive promotor. In one embodiment of the disclosure, the adhesive promoter may be one or more selected from epoxy silane, alkoxy silane, acyloxy silane, aryloxy silane or oligomers thereof. They include, but are not limited to, 3-glycidoxypropyl trimethoxy silane, octyltriethoxysilane, vinyltriethoxysilane, vinyltrimethoxysilane, gamma-methacryloxy-propyltrimethoxysilane, beta-(3,4-epoxycyclohexyl)-ethyltrimethoxysilane beta-(3,4-epoxycyclohexyl)-ethyltriethoxysilane and bis (trimethoxysilyl propyl) fumarate, alkoxy or aryloxy silicones such as trimethoxysilyl functional groups modified silicones. Furthermore, they also include silanols, oligosiloxanes containing one or more alkoxy silyl functional group, polysiloxanes containing alkoxysilyl functional group, one or more oligomeric siloxanes containing hydroxyl functional groups, polysiloxanes containing one or more aryloxy silyl functional group, cyclosiloxanes containing one or more alkoxy silyl functional group, cyclosiloxanes containing one or more hydroxyl groups, tetra-alkoxy silanes, vinyltrimethoxysilane, and mixtures thereof, and combinations thereof.

However, the amount of the adhesive promoter in the silicone coating composition has to be controlled within the scope of 0 to 5 parts, preferably 0 to 3 parts, most preferably 0 parts by total weight of whole composition. With more adhesive promoter, the overall properties of the cured silicone coating composition would be notably deteriorated and the preparation for the silicone coating composition would also be adversely affected.

Examples of the component that may be additionally contained in the composition include pigment, colorant or other fillers like fumed silica, calcium carbonate, quartz, Wollastonite, cerium oxides, Al(OH)₃, Fe₂O₃, Al₂O₃, mica, talc, MgO, Mg(OH)₃, TiO₂. But, these fillers are preferably used in an amount of less than 30% by total weight of whole composition, preferably less than 10% by weight or more preferably less than 5% or most preferably 0%, since high amount of these fillers will not contribute to any further improvement of the hand feeling and mechanical properties or even make them worse.

Another additive that may be added into the silicone coating composition is the crosslinking inhibitor which are conventionally employed in polyaddition crosslinking reactions in the silicone field. They may especially be chosen from the following compounds:

organopolysiloxanes substituted by at least one alkenyl which may optionally be present in cyclic form, with tetramethylvinyltetrasiloxane being particularly preferred; organic phosphines and phosphites; unsaturated amides; alkylated maleates; and acetylenic alcohols.

As acetylenic alcohols, they are also preferred thermal blockers for the hydrosilylation reaction. Examples of acetylenic alcohols include especially 1-ethynyl-1-cyclohexanol, 3-methyl-1-dodecyn-3-ol, 3,7,11-trimethyl-1-dodecyn-3-ol, 1,1-diphenyl-2-propyn-1-ol, 3-ethyl-6-ethyl-1-nonyn-3-ol, 2-methyl-3-butyn-2-ol, 3-methyl-1-penta-decyn-3-ol, diallyl maleate or derivatives of diallyl maleate or mixture thereof.

Such an inhibitor may be present in an amount of from 0.005 wt % to 1.5 wt % by total weight of whole composition, preferably from 0.01 wt % to 1 wt %.

The silicone coating composition may be prepared simply by uniformly mixing together or in order, at a normal temperature or elevated temperature, the individual components as specified above. Generally, the coating composition have a viscosity at 25° C. of about 1 to 400 Pa·s and especially about 5 to 50 Pa·s.

Adhesive Layer

An adhesive layer is usually required in the inventive multi-layered composite as a second layer which functions, for example, as an intermediate layer between the substrate and the top coat, i.e. the silicone coating composition as specified above. Such an adhesive layer is well known and the composition thereof can be formulated and adjusted by the skilled person.

The adhesive layer is preferably a silicone adhesive layer and contains or consists of liquid silicone rubber (LSR) or room temperature vulcanized silicone rubber (RTV), including without limitation any base material. In one exemplary embodiment, the second adhesive layer is formed by a silicone adhesive composition comprising:

(AA) at least one organopolysiloxane polymer having at least two alkene functions;

(BB) at least one cross-linking organohydrogensiloxane having at least two Si—H groups;

(CC) a catalyst capable of promoting the reaction between component (AA) and component (BB); and

(EE) adhesive promoter.

The general descriptions and preferences for components (A), (B) and (C) used in the silicone coating composition as discussed above apply also for the components (AA), (BB) and (CC) of the silicone adhesive layer composition which make up the basis of the adhesive composition, wherein however there are no three-dimensional net-like organohydrogensiloxane resin, i.e. component (B′) as defined above, in component (BB) of the silicone adhesive composition. The molar ratio of the silicon-bonded hydrogen atoms to the silicon-bonded vinyl group as discussed above also applies for the silicone adhesive layer composition. Likewise, the adhesive layer may also contain other additives like the fillers, adhesive promoter and crosslinking inhibitor as indicated in the paragraph under the subtitle “Other optional components”.

In the adhesive layer, especially the silicone adhesive layer may contain the fillers in an amount of 5 to 50 parts by weight, preferably at least 10 to 40 parts by weight, per 100 parts by weight of the adhesive layer. However, the specific spherical filler particles as used in the silicone coating composition are not used in the adhesive layer.

As for the adhesive promotors, it is necessary and preferably present in the adhesive layer. The adhesive promoters may be added in an amount of in an amount of 0.2 wt % to 10 wt %, preferably 0.5 wt % to 8 wt %, more preferably 0.8 wt % to 5 wt % of the total weight of the adhesive layer.

Therefore, the skilled person is aware that the silicone adhesive layer used as the second layer has to be different from the third top coat, i.e. the inventive silicone coating composition, with regard to the composition.

In the multi-layered composite, the coat weight of second layer is 100-300 gsm (i.e. g/m²), preferably 130-280 gsm and more preferably 150-250 gsm. The coat weight of the top coat layer is of 5 gsm to 250 gsm, preferably 10 gsm to 200 gsm, more preferably 15 gsm to 100 gsm, most preferably 15 gsm to 40 gsm. The total coating weight of second layer and third layer, i.e. top coat, is more than 105 gsm, preferably more than 150 gsm.

Furthermore, the invention relates to a product containing such a multi-layered composite, preferably an artificial leather, an airbag and an apparel.

Finally, the instant disclosure relates to use of the inventive silicone coating composition for surface modification of silicone coated textiles, such as in heat shielding and DWR coatings, silicone inks in textile screen printing, airbags and injection molded parts, and for applying directly to textile for apparel printing. In one embodiment of this surface modification, the silicone coating composition may be applied, such as coated, sprayed or printed, on the multi-layered composite as a top coat.

### EXAMPLES

The invention will be further described with reference to following examples, wherein all parts refer to the parts by weight unless other indicated.

Measurement of the Properties:

The mechanical properties are determined with known techniques:

Hardness of the silicone elastomeric materials was measured by type A durometer in accordance with GB/T 531.1,

Tensile strength and elongation at break were measured in accordance with GB/T 6344, and Tear strength was measured in accordance with ASTM D624 B.

The viscosities are values measured with a rotational viscometer.

Abrasion-Resistance:

Test Equipment: Wyzenbeek

Test stander: ASTM D4157

Test abradant: 10# cotton duck

Test starting condition: Equilibrium is considered to have been reached when the increase in weight of the specimen in successive weighing made at intervals of not less than 2 h does not exceed 0.1% of the weight of the specimen.

Recording the maximum number of scrubbings on the coating of the specimen, over which more scrubbings would bring the change of the surface and thus the surface cannot be rated as the best Ranking 5 anymore. The maximum abrasion times was listed in the Wyzenbeek-row in table 1 (with unit “w” meaning per 10000 times).

Hand Feeling for Coated Fabric:

The hand feeling of coating film was evaluated by touch with finger, we made following standards for every test:

| Level of hand feeling | State description |
|---|---|
| +++++ | Feel better smooth and soft |
| ++++ | Good smooth and soft |
| +++ | Feel normal |
| + | tack |

General Procedure for Preparing the Testing Sample:

Several silicone coating mixtures were prepared by mixing with varying compositions and amounts as listed in table 1 for respective examples, then applied on the surface of the casting paper with a coating weight of 20 gsm and it was cured in the oven at the temperature of 130° C. for 5 min.

After the silicone coating layer (i.e. top coat) was cured and dried, a second adhesive layer was coated on it and then a fabric is put on the second layer as the substrate using a roller without pressure. For all inventive and comparative examples, the same adhesive layer was prepared and used. The second adhesive layer composition was comprising 100 parts by weight of component AA, 4 parts by weight of component BB, 0.03 parts by weight of component CC, 27 parts by weight of fumed silica, 1.35 parts by weight of adhesive promotor and 0.4 parts by weight of crosslinking inhibitor. The coating weight of the second adhesive layer was 180 gsm and then the prepared composite was cured at the temperature of 140° C. for 10 min.

After finally peeling the casting paper, a three layered composite of silicone artificial leather was obtained.

### Inventive Examples and Comparative Example

Raw Materials of the Top Coat, Silicone Coating Composition:

| | |
|---|---|
| Component A-1 | vinyl terminal-polydimethylsiloxane oil, vinyl content 0.08 wt %, |
| | viscosity 60,000 mpas |
| Component A-2 | Vinyl MQ resin, vinyl content 0.31 wt % |
| Compoent B-1 | Methyl hydrogen silicone oil, the SiH is in chain with content of 20 wt % |
| Component B-2 | methyl hydrogen MQ resin with SiH content of 24 wt % |
| Component D-1 | Fumed Silica, D50 = 4 μm |
| Component D-2 | T unit silicone resin, D50 = 4 μm |
| Component D-3 | Polyamide 6 resin particles, D50 = 20 μm |
| Component D-4 | Precipitated silica, D50 = 4.4 μm |
| Component D-5 | T unit silicone resin micropearl, D50 = 0.8 μm |
| Component D-6 | T unit silicone resin micropearl, D50 = 2 μm |
| Component D-7 | T unit silicone resin micropearl, D50 = 8 μm |
| Component D-8 | T unit silicone resin micropearl, D50 = 15 μm |
| Component D-9 | talc, D50 = 10 μm, lamellar material |
| Component D-10 | MDT unit silicone resin microperal (D unit is about 70 mol %), D50 = 10 |
| | μm |
| Component D-11 | A dispersion of Component D-10 in 80-90 wt % of D5 |
| Component C | platinum catalyst, 25 ppm by total weight of the composition |
| Inhibitor | ethynylcyclohexanol (ECH) |

Raw Materials of the Silicone Adhesive Layer:

| | |
|---|---|
| Component AA | vinyl terminal-polydimethylsiloxane oil, vinyl content 0.08 wt %, |
| | viscosity 60,000 mpas |
| Component BB | Organohydrogensiloxane oil, SiH terminal-polydimethylsiloxane oil, SiH |
| | content 20 wt % |
| Component CC | platinum catalyst, 25 ppm by total weight of the composition |
| Filler | Fumed Silica, BET is around 300 g/m² |
| Adhesive promotor | 3-glycidoxypropyl trimethoxy silane |
| Inhibitor | ethynylcyclohexanol (ECH) |

TABLE 1

| | EX1 | EX2 | EX3 | EX4 | EX5 | EX6 | EX7 | EX8 | EX9 | EX10 | EX11 |
|---|---|---|---|---|---|---|---|---|---|---|---|
| A-1 | 100 | 100 | 100 | 100 | 100 | 100 | 100 | 100 | 100 | 100 | 100 |
| A-2 | 49.7 | 49.7 | 49.7 | 49.7 | 49.7 | 49.7 | 49.7 | 49.7 | 49.7 | 49.7 | 49.7 |
| B-2 | 11.8 | 11.8 | 11.8 | 11.8 | 11.8 | 11.8 | 11.8 | 11.8 | 11.8 | 11.8 | 11.8 |
| D-1 | 7.7 | 7.7 | 7.7 | 7.7 | 7.7 | 7.7 | 7.7 | 7.7 | 7.7 | 7.7 | 7.7 |
| D-2 | / | 16.6 | / | / | / | / | / | / | 1.86 | 7.44 | 27.9 |
| D-3 | / | / | 16.6 | / | / | / | / | / | / | / | / |
| D-4 | / | / | / | 16.6 | / | / | / | / | / | / | / |
| D-5 | / | / | / | / | 16.6 | / | / | / | / | / | / |
| D-6 | / | / | / | / | / | 16.6 | / | / | / | / | / |
| D-7 | / | / | / | / | / | / | 16.6 | / | / | / | / |
| D-8 | / | / | / | / | / | / | / | 16.6 | / | / | / |
| C | 0.03 | 0.03 | 0.03 | 0.03 | 0.03 | 0.03 | 0.03 | 0.03 | 0.03 | 0.03 | 0.03 |
| Inhibitor | 0.4 | 0.4 | 0.4 | 0.4 | 0.4 | 0.4 | 0.4 | 0.4 | 0.4 | 0.4 | 0.4 |
| Coating | 20 | 20 | 20 | 20 | 20 | 20 | 20 | 20 | 20 | 20 | 20 |
| weight (gsm) | | | | | | | | | | | |
| Shore A | 61 | 71 | 65 | 73 | 72 | 72 | 69 | 73 | 67 | 70 | 75 |
| Hardness | | | | | | | | | | | |
| Tensile | 6.1 | 7.1 | 7.31 | 8.4 | 6.7 | 7.4 | 7.7 | 6.5 | 7.0 | 7.4 | 7.1 |
| strength/Mpa | | | | | | | | | | | |
| Elongation at | 68 | 76 | 72.9 | 82.5 | 51 | 52 | 61 | 55 | 76.5 | 67.5 | 68.6 |
| break/% | | | | | | | | | | | |
| Tear strength/ | 7.0 | 10.4 | 11.2 | 14.6 | 9.1 | 8.7 | 9.6 | 8.5 | 10.8 | 7.9 | 8.4 |
| KN/m | | | | | | | | | | | |
| Wyzenbeek | 5 w | 30 w | 14 w | 12 w | 20 w | 25 w | 20 w | 15 w | 7 w | 15 w | 25 w |
| Handfeeling | +++ | +++++ | ++++ | ++++ | +++++ | +++++ | +++++ | +++++ | +++ | +++++ | +++++ |

| | EX 12 | EX13 | EX14 | EX15 | EX16 | EX 17 | EX 18 | EX19 | EX20 | EX23 |
|---|---|---|---|---|---|---|---|---|---|---|
| A-1 | 100 | 100 | 100 | 100 | 100 | 100 | 100 | 100 | 100 | 100 |
| A-2 | 49.7 | 49.7 | 49.7 | 49.7 | 49.7 | 49.7 | 49.7 | 49.7 | 5.26 | 8.69 |
| B-2 | / | 5.9 | 3.54 | 11.8 | 11.8 | 11.8 | 11.8 | 11.8 | 11.8 | 11.8 |
| B-1 | 11.8 | 5.9 | 8.26 | / | / | / | / | / | / | / |
| D-1 | 7.7 | 7.7 | 7.7 | 24.3 | / | / | / | / | / | / |
| D-2 | 16.6 | 16.6 | 16.6 | / | 24.3 | 1 | 50 | / | 16.6 | 16.6 |
| D-3 | / | / | / | / | / | / | / | / | / | / |
| D-4 | / | / | / | / | / | / | / | / | / | / |
| D-5 | / | / | / | / | / | / | / | / | / | / |
| D-6 | / | / | / | / | / | / | / | / | / | / |
| D-7 | / | / | / | / | / | / | / | / | / | / |
| D-8 | / | / | / | / | / | / | / | / | / | / |
| D-9 | / | / | / | / | / | / | / | 16.6 | / | / |
| C | 0.03 | 0.03 | 0.03 | 0.03 | 0.03 | 0.03 | 0.03 | 0.03 | 0.03 | 0.03 |
| Inhibitor | 0.4 | 0.4 | 0.4 | 0.4 | 0.4 | 0.4 | 0.4 | 0.4 | 0.4 | 0.4 |
| Coating | 20 | 20 | 20 | 20 | 20 | 20 | 20 | 20 | 20 | 20 |
| weight (gsm) | | | | | | | | | | |
| Shore A | 56 | 65 | 61 | 69 | 78 | 64 | 76 | 68 | 57 | 61 |
| Hardness | | | | | | | | | | |
| Tensile | 7.1 | 7.0 | 6.8 | 8.1 | 7.7 | 6.8 | 7 | 6.3 | 6.8 | 6.9 |
| strength/Mpa | | | | | | | | | | |
| Elongation at | 168 | 85 | 100 | 88 | 42 | 104 | 65 | 77 | 80 | 80 |
| break/% | | | | | | | | | | |
| Tear strength/ | 9.5 | 10.0 | 9.8 | 11.1 | 6 | 6.5 | 12 | 10.6 | 9 | 9.2 |
| KN/m | | | | | | | | | | |
| Wyzenbeek | 1.5 w | 21 w | 14 w | 7 w | 28 w | 2 w | 5 w | 4 w | 2 w | 10 w |
| Handfeeling | +++ | ++++ | ++++ | +++ | +++++ | +++ | +++ | +++ | +++ | ++++ |

| | EX21 | EX22 |
|---|---|---|
| A | 100 | 100 |
| A′ | 49.7 | 49.7 |
| B′ | 11.8 | 11.8 |
| D-1 | 7.7 | 7.7 |
| D-2 | / | / |
| D-3 | / | / |
| D-4 | / | / |
| D-5 | / | / |
| D-6 | / | / |
| D-7 | / | / |
| D-8 | / | / |
| D-9 | / | / |
| D-10 | / | 16.6 |
| D-11 | 16.6 | / |
| C | 0.03 | 0.03 |
| Inhibitor | 0.4 | 0.4 |
| Coating | 20 | 20 |
| weight (gsm) | | |
| Shore A | 69 | 65 |
| Hardness | | |
| Tensile | 8 | 7.4 |
| strength/Mpa | | |
| Elongation at | 72 | 77 |
| break/% | | |
| Tear strength/ | 8.4 | 8.6 |
| KN/m | | |
| Wyzenbeek | 30 W | 15 W |
| Handfeeling | +++++ | ++++ |

1. A multi-layered composite comprising a substrate, an adhesive layer and a top coat layer, the top coat layer being formed by a silicone coating composition comprising the following components:
(A) at least one organopolysiloxane polymer having at least two alkene functions comprising:
(i) at least two units of formula (I-1)
R¹ₐZ_{b}SiO_{[4-(a+b)]/2} (I-1)
in which
R¹ represents a monovalent radical containing from 2 to 12 carbon atoms, having at least one alkene function,
Z which can be the same or different and represents a monovalent radical comprising from 1 to 20 carbon atoms and does not comprise an alkene function,
a is an integer of 1, 2 or 3, b is an integer of 0, 1 or 2 and the sum of a+b is 1, 2 or 3,
(ii) and optionally other units of formula (I-2):
Z_{c}SiO_{(4-c)/2} (I-2)
in which
Z has the same meaning as above, and
cis an integer of 0, 1, 2 or 3;
(B) at least one cross-linking organohydrogensiloxane having at least two Si—H groups; and
(C) a catalyst that promotes a reaction between component (A) and component (B);
wherein the component (B) comprises at least about 25 wt weight of component (B) of a three-dimensional net-like organohydrogensiloxane resin (B′) comprising at least two different units selected from the group consisting of:
units M of formula R′₃SiO_{1/2},
units D of formula R′₂SiO_{2/2},
units T of formula R′SiO_{3/2} and
units Q of formula SiO_{4/2}, wherein R′ represents a hydrogen atom or a monovalent hydrocarbonyl group having from 1 to 20 carbon atoms, and
with the proviso that at least one of these units is the unit T or Q, and at least one of the units M, D and T comprises a hydrogen atom.

2. The multi-layered composite according to claim 1, wherein the component (A) comprises from about 8 wt % to about 80 wt %, by total weight of the component (A) of alkenyl organopolysiloxane resin (A′) comprising:
at least two different units selected from the group consisting of units M of formula R₃SiO_{1/2}, units D of formula R₂SiO_{2/2}, units T of formula RSiO_{3/2} and units Q of formula SiO_{4/2}, wherein R have the meanings given for groups R¹ or Z in claim 1,
with the proviso that at least one of these units is the siloxane unit T or Q and at least two of the units M, D and T comprises an alkene function.

3. The multi-layered composite according to claim 1, wherein the component (B) comprises about 100 wt % of the three-dimensional net-like organohydrogensiloxane resin (B′).

4. The multi-layered composite according to claim 1, wherein the mole molar ratio of the M unit to the Q unit in said organohydrogensiloxane resin (B′) is from about 0.5 mol/mol to about 8 mol/mol.

5. The multi-layered composite according to claim 1, wherein the molar ratio of silicon-bonded hydrogen atoms to the sum of the silicon-bonded vinyl groups in the whole composition is from about 0.8 mol/mol to about 10 mol/mol.

6. The multi-layered composite according to claim 1, wherein the composition comprises component (D) which is composed of spherical particle fillers with a particle size D50 from about 0.2 μm to about 60 μm.

7. The multi-layered composite according to claim 6, wherein the amount of component (D) is from about 1 wt % to about 30 wt %, by total weight of whole silicone coating composition.

8. The multi-layered composite according to claim 6, wherein component (D) is selected from the group consisting of: precipitated silica particles, spherical silicone resin particles, polyamide particles and mixtures thereof.

9. The multi-layered composite according to claim 8, said wherein the spherical silicone resin particles are particles of silicone resin material formed by polysiloxanes of the general formula of
R⁶ₘSiXₙP_{(4-m-n)/2},
where R⁶ is an alkyl, aryl, aralkyl or alkylaryl group having two or more carbon atoms,
X is a functional group selected from the group consisting of an epoxy group, an alkoxyl group, a vinyl group, a hydrogen group, an acryloxy group, a methacryloxy group, a polyethylene glycol group, a hydroxy group, and an amino group,
m is an integer of 0 to 2,
n is an integer of 0 to 1, and
m+n is 0 to 3.

10. The multi-layered composite according to claim 9, said wherein the silicone resin material is formed by polysiloxane comprising siloxane units selected from the group consisting of: unit M of R⁷₃SiO_{0.5}, unit D of R⁷₂SiO, unit T of R⁷SiO_{3/2} and unit Q of SiO_{4/2},
wherein R⁷ is selected from the group consisting of: a methyl, an ethyl, a phenyl, a phenylethyl a 3 phenylpropyl groups, a hydroxyl, acryloxy, a methacryloxy, a hydrogen, an epoxy, and an amino group,
with the proviso that the amount of unit T or unit D is higher than about 50 mol %.

11. The multi-layered composite according to claim 8, wherein spherical silicone resin particles are added into the silicone coating composition in the form of a dispersion with the content of about 10 wt % to about 30 wt % based on the total weight of the dispersion.

12. The multi-layered composite according to claim 1, wherein the silicone coating composition comprises a crosslinking inhibitor.

13. The multi-layered composite according to claim 1, wherein the coat weight of the top coat layer is from about 5 gsm to about 250 gsm.

14. The multi-layered composite according claim 1, wherein the abrasion resistance of the top coat layer is ranked according to ASTM D4157 at Ranking 5 after at least about 100,000 scrubbing.

15. The multi-layered composite according to claim 1, wherein the adhesive layer is formed by a silicone adhesive composition.

16. The multi-layered composite according to claim 1, wherein the adhesive layer contains no three-dimensional net-like organohydrogensiloxane resin (B′) and/or no component (D), which is a component selected from the group consisting of: precipitated silica particles, spherical silicone resin particles, polyamide particles and mixtures thereof.

17. The multi-layered composite according claim 1, wherein the adhesive layer comprises an adhesive promotor in an amount from about 0.2 wt % to about 10 wt % by total weight of the adhesive layer.

18. The multi-layered composite according to claim 17, wherein the adhesive promotor is one or more selected from the group consisting of epoxy silane, alkoxy silane, acyloxy silane, aryloxy silane, oligomers thereof and combinations thereof.

19. The multi-layered composite according to claim 1, wherein the substrate is a fabric or film or sheet based on the polymers selected from the group consisting of polypropylene, polyethylene, fiberglass, polyamides, polyurethane and polyvinyl chloride, poly(ethylene) terephthalate and other polymers and mixtures thereof.

20. A product comprising the multi-layered composite according to claim 1.

21. The product according to claim 20, wherein the product is an artificial leather, an airbag or apparel.

22. A silicone coating composition comprising following components:
(A) at least one organopolysiloxane polymer having at least two alkene functions comprising:
(i) at least two units of formula (I-1)
R¹ₐZ_{b}SiO_{[4-(a+b)]/2} (I-1)
in which
R¹ represents a monovalent radical containing from 2 to 12 carbon atoms, having at least one alkene function,
Z is the same or different and represents a monovalent radical comprising from 1 to 20 carbon atoms and does not comprise an alkene function,
a is an integer of 1, 2 or 3, b is an integer of 0, 1 or 2 and the sum of a+b is 1, 2 or 3,
(ii) and optionally other units of formula (I-2):
Z_{c}SiO_{(4-c)/2} (1-2)
in which
Z has the same meaning as above, and
cis an integer of 0, 1, 2 or 3;
(B) at least one cross-linking organohydrogensiloxane having at least two Si—H groups;
(C) a catalyst that promotes a reaction between component (A) and component (B);
(D) spherical particle fillers with a particle size D50 from about 0.2 μm to about 60 μm, in an amount of from about 2 wt % to about 50 wt by total weight of component (A);
wherein the component (B) comprises at least about 25 wt % by weight of a three-dimensional net-like organohydrogensiloxane resin (B′) comprising at least two different units selected from the group consisting of
units M of formula R′₃SiO_{1/2},
units D of formula R′₂SiO_{2/2},
units T of formula R′SiO_{3/2} and
units Q of formula SiO_{4/2}, wherein R′ represents hydrogen atom or a monovalent hydrocarbon group having from 1 to 20 carbon atoms, and
with the proviso that at least one of these units is the unit T or Q and at least one of the units M, D and T comprises a hydrogen atom.

23. The silicone coating composition according to claim 22, wherein component (D) is selected from the group consisting of: precipitated silica particles, spherical silicone resin particles, polyamide particles, silicone elastomer particles and mixtures thereof.

24. The silicone coating composition according to claim 22, wherein the composition further comprises a crosslinking inhibitor and/or a fumed silica.

25. The silicone coating composition according to claim 22, wherein the component (A) comprises from about 8 wt % to about 80 wt % by total weight of the component (A) of alkenyl polysiloxane resin (A′) comprising:
at least two different units selected from the group consisting of units M of formula R₃SiO_{1/2}, units D of formula R₂SiO_{2/2}, units T of formula RSiO_{3/2} and units Q of formula SiO_{4/2}, wherein R have the meanings given for groups R¹ or Z in claim 1, with the proviso that at least one of these units is the siloxane unit T or Q and at least two of the units M, D and T comprises an alkenyl group.

26. A method of making a silicone coated textile, the method comprising using the silicone coating composition according to claim 22 to surface modify the silicone coated textile in an application selected from the group consisting of heat shielding, durable water repellent (DWR) coating, silicone inks in textile screen printing, airbags and injection molding of parts, and for applying directly to textile for apparel printing.

27. The multi-layered composite according to claim 1, wherein the at least one cross-linking organohydrogensiloxane (B) comprises at least three Si—H groups.

28. The multi-layered composite according to claim 1, wherein the component (B) comprises at least about 30% by weight of the three-dimensional net-like organohydrogensiloxane resin (B′).

29. The multi-layered composite according to claim 1, wherein the component (B) comprises at least about 45% by weight of the three-dimensional net-like organohydrogensiloxane resin (B′).

30. The multi-layered composite according to claim 1, wherein at least one of the units M, D, T and Q of the three-dimensional net-like organohydrogensiloxane resin (B′) is Q.

31. The multi-layered composite according to claim 1, wherein at least two of the units M, D and T comprises a hydrogen atom.

32. The multi-layered composite according to claim 2, wherein the component (A′) comprises from about 10 wt % to about 60 wt % of the alkenyl organopolysiloxane resin (A′).

33. The multi-layered composite according to claim 2, wherein the component (A′) comprises from about 15 wt % to about 50 wt % of the alkenyl organopolysiloxane resin (A′).

34. The multi-layered composite according to claim 2, wherein the at least two of the units M, D and T comprises an alkenyl group as the alkene function.

35. The multi-layered composite according to claim 4, wherein the molar ratio of the M unit to the Q unit is from about 0.5 mol/mol to about 6 mol/mol.

36. The multi-layered composite according to claim 4, wherein the molar ratio of the M unit to the Q unit is from about 0.8 mol/mol to about 5 mol/mol.

37. The multi-layered composite according to claim 5, wherein the molar ratio of silicon-bonded hydrogen atoms to the sum of the silicon-bonded vinyl groups in whole composition is from about 1.1 mol/mol to about 6 mol/mol.

38. The multi-layered composite according to claim 5, wherein the molar ratio of silicon-bonded hydrogen atoms to the sum of the silicon-bonded vinyl groups in whole composition is from about 1.2 mol/mol to about 5 mol/mol.

39. The multi-layered composite according to claim 6, wherein the spherical particle fillers have a particle size D50 of from about 0.5 μm to about 40 μm.

40. The multi-layered composite according to claim 6, wherein the spherical particle fillers have a particle size D50 of from about 0.8 μm to about 30 μm.

41. The multi-layered composite according to claim 7, wherein the amount of component (D) is from about 1.5 wt % to about 25 wt %.

42. The multi-layered composite according to claim 7, wherein the amount of component (D) is from about 2 wt % to about 20 wt %.

43. The multi-layered composite according to claim 9, wherein R⁶ is an alkyl, aryl, aralkyl or alkylaryl group having 2 to 6 carbon atoms.

44. The multi-layered composite according to claim 43, wherein R⁶ is selected from the group consisting of a methyl, an ethyl, a phenyl, a phenylethyl and a 3-phenylpropyl groups.

45. The multi-layered composite according to claim 10, wherein the amount of unit T or unit D is higher than about 70 mol %.

46. The multi-layered composite according to claim 10, wherein the amount of unit T or unit D is higher than about 80 mol %.

47. The multi-layered composite according to claim 11, wherein the added spherical silicone resin particles are present in the silicone coating composition in a content of about 10 wt. % to about 20 wt. % based on the total weight of the dispersion.

48. The multi-layered composite according to claim 13, wherein the coat weight of the top coat layer is from about 10 gsm to about 200 gsm.

49. The multi-layered composite according to claim 13, wherein the coat weight of the top coat layer is from about 15 gsm to about 100 gsm.

50. The multi-layered composite according to claim 13, wherein the coat weight of the top coat layer is from about 15 gsm to about 40 gsm.

51. The multi-layered composite according to claim 17, wherein the adhesive promoter is present in an amount of from of about 0.5 wt. % to about 8 wt.

52. The multi-layered composite according to claim 17, wherein the adhesive promoter is present in an amount of from of about 0.8 wt. % to about 5 wt.

53. The silicone coating composite according to claim 22, wherein the at least one cross-linking organohydrogensiloxane has at least three Si—H groups.

54. The silicone coating composite according to claim 22, wherein the spherical particle fillers (D) have a particle size of from about 0.5 μm to about 40 μm.

55. The silicone coating composite according to claim 22, wherein the spherical particle fillers (D) have a particle size of from about 0.8 μm to about 30 μm.

56. The silicone coating composite according to claim 22, wherein the spherical particle fillers (D) are present in an amount of from about 2 wt % to about 40 wt %.

57. The silicone coating composite according to claim 22, wherein the spherical particle fillers (D) are present in an amount of from about 5 wt % to about 35 wt %.

58. The silicone coating composite according to claim 22, wherein under the proviso the at least one unit of units T and Q is unit Q and wherein two of units M, D and T comprise the hydrogen atom.

59. The silicone coating composite according to claim 25, wherein component (A) comprises from about 10 wt. % to about 60 wt. % of the alkenyl polysiloxane resin (A′).

60. The silicone coating composite according to claim 25, wherein component (A) comprises of from about 15 wt. % to about 50 wt. % of the alkenyl polysiloxane resin (A′).
